(19) United States
(12) Patent Application Publication
(10) Pub. No.: US 2026/0254225 A1
(43) Pub. Date: Aug. 27, 2026

(54) CIRCUIT BREAKER DEVICE AND METHOD

(71) Applicant: Siemens Aktiengesellschaft, München (DE)

(72) Inventor: Marvin Tannhäuser, Hausen (DE)

(21) Appl. No.: 19/160,125

(22) PCT Filed: Jan. 26, 2024
(86) PCT No.: PCT/EP2024/051954

§ 371 Date: Aug. 27, 2025

(30) Foreign Application Priority Data
Feb. 27, 2023 (DE) 10 2023 201 779.2

(51) Int. Cl. H02H 3/02; H02H 1/00; H02H 3/04; H02H 3/05; H02H 3/08

(52) U.S. Cl. CPC H02H 3/021; H02H 1/0007; H02H 3/04; H02H 3/05; H02H 3/083

(57) ABSTRACT

A circuit breaker device protects an electric multi-phase low-voltage alternating current circuit. The device contains a housing having grid-side phase connections and load-side phase connections for phase conductors of the low-voltage alternating current circuit. Series circuits of the device each contain a mechanical phase contact and an electronic switch. Each series circuit electrically connects a grid-side phase connection to one of the load-side phase connections. The mechanical phase contacts are switched together to an open state to prevent a current flow or to a closed state for a current flow, by use of semiconductor-based switch elements. In each series circuit, the level of the current of the respective phase conductor is ascertained. If a first current threshold or current/time threshold is exceeded in a phase conductor, a prevention of the current flow is initiated, and the electronic switches are switched to a high-ohmic or low-ohmic state by a control input.

The invention relates to the technical field of a circuit breaker device for a multiphase low-voltage AC circuit having electronic switches and to a method for a circuit breaker device for a multiphase low-voltage AC circuit having electronic switches.

Low voltage is understood to mean voltages of up to 1000 volts AC or up to 1500 volts DC. Low voltage is understood in particular to mean voltages that are greater than extra-low voltage, with values of 50 volts AC or 120 volts DC.

A low-voltage circuit or grid or installation is understood to mean circuits with nominal currents or rated currents of up to 125 amperes, more specifically up to 63 amperes. A low-voltage circuit is understood to mean in particular circuits with nominal currents or rated currents of up to 50 amperes, 40 amperes, 32 amperes, 25 amperes, 16 amperes or 10 amperes. Said current values are understood to mean in particular nominal, rated or/and shutdown currents, that is to say the maximum current that is normally carried through the circuit or in the case of which the electrical circuit is usually interrupted, for example by a protection device, such as a circuit breaker device, miniature circuit breaker or power circuit breaker. The nominal currents may be staggered further, from 0.5 A through 1 A, 2 A, 3 A, 4 A, 5 A, 6 A, 7 A, 8 A, 9 A, 10 A, etc. up to 16 A.

Miniature circuit breakers are overcurrent protection devices that have long been known and that are used in low-voltage circuits in electrical installation engineering. They protect lines against damage caused by heating due to excessively high current and/or a short circuit. A miniature circuit breaker may automatically shut down the circuit in the event of an overload and/or short circuit. A miniature circuit breaker is not a safety element that resets automatically.

In contrast to miniature circuit breakers, power circuit breakers are intended for currents greater than 125 A, in some cases also starting from 63 amperes. Miniature circuit breakers therefore have a simpler and more delicate design. Miniature circuit breakers usually have a fastening option for fastening to a so-called top-hat rail (carrier rail, DIN rail, TH35).

Miniature circuit breakers have an electromechanical design. In a housing, they have a mechanical switching contact or operating current tripping device for interrupting (tripping) the electric current. A bimetal protection element or bimetal element is usually used for tripping (interruption) in the event of a sustained overcurrent (overcurrent protection), respectively in the event of a thermal overload (overload protection). An electromagnetic tripping device with a coil is used for brief tripping in the event of an overcurrent limit value being exceeded or in the event of a short circuit (short circuit protection). One or more arc extinguishing chambers or arc extinguishing devices are provided. Connection elements for conductors of the electrical circuit to be protected are also provided.

Circuit breaker devices having an electronic interruption unit or an electronic switch are relatively recent developments. They have a semiconductor-based electronic interruption unit or a semiconductor-based electronic switch. In other words, the electric current flow in the low-voltage circuit is guided via semiconductor components or semiconductor switches that are able to interrupt the electric current flow or are able to be switched to the on state. Circuit breaker devices having an electronic interruption unit often also have a mechanical isolating contact unit, in particular with isolator properties in accordance with the applicable standards for low-voltage circuits, wherein the contacts of the mechanical isolating contact unit are connected in series with the electronic interruption unit, that is to say the current of the low-voltage circuit to be protected is guided both through the mechanical isolating contact unit and through the electronic interruption unit.

The present invention relates in particular to (multiphase) low-voltage AC circuits having an AC voltage, usually having a time-dependent sinusoidal AC voltage of frequency f. The temporal dependency of the instantaneous voltage value u(t) of the AC voltage is described by the equation:

$$u ( t ) = U * sin ( 2 π * f * t ) ,$$

wherein:
u(t)=instantaneous voltage value at the time t
U=amplitude of the voltage

A harmonic AC voltage may be represented by the rotation of a vector the length of which corresponds to the amplitude (U) of the voltage. The instantaneous deviation is in this case the projection of the vector onto a coordinate system. An oscillation period corresponds to a full revolution of the vector and its full angle is 2π (2pi) or 360°. The angular frequency is the rate of change of the phase angle of this rotating vector. The angular frequency of a harmonic oscillation is always 2π times its frequency, that is to say:

$$\begin{matrix}ω = 2 π * f = 2 π / T = angular frequency of the AC voltage \\ ( T = period duration of the oscillation ) .\end{matrix}$$

It is often preferred to give the angular frequency (ω) rather than the frequency (f), since many formulae in oscillation theory are able to be represented more compactly using the angular frequency due to the occurrence of trigonometric functions the period of which is by definition 2π:

$$u ( t ) = U ⋆ sin ( ω t )$$

In the case of non-temporally constant angular frequencies, the term instantaneous angular frequency is also used.

In the case of a sinusoidal, in particular temporally constant, AC voltage, the time-dependent value formed from the angular velocity ω and time t corresponds to the time-dependent angle φ(t), which is also referred to as phase angle φ(t). In other words, the phase angle φ(t) periodically runs through the range 0 . . . 2π or 0° . . . 360°. In other words, the phase angle periodically adopts a value between 0 and 2π or 0° and 360° (φ=n*(0 . . . 2π) or φ=n*(0° . . . 360°), owing to pe-riodicity; for short: φ=0 . . . 2π or φ=0° . . . 360°).

Instantaneous voltage value u(t) is therefore understood to mean the instantaneous value of the voltage at the time t, that is to say, in the case of a sinusoidal (periodic) AC voltage, the value of the voltage at the phase angle φ(φ=0 . . . 2π or φ=0° . . . 360°, of the respective period).

The object of the present invention is to improve a circuit breaker device of the type mentioned at the outset, in particular to achieve greater flexibility and a novel feature for the circuit breaker device.

This object is achieved by a circuit breaker device having the features of patent claim 1, and by a method as claimed in patent claim 20.

According to the invention, what is proposed is a circuit breaker device for protecting an electrical multiphase low-voltage AC circuit, having:
a housing having grid-side phase connections and load-side phase connections for phase conductors of the multi-phase low-voltage AC circuit,
series circuits consisting of a mechanical phase contact and an electronic switch,
wherein a respective series circuit electrically connects one of the grid-side phase connections to one of the load-side phase connections,
wherein the mechanical phase contacts are able to be switched together so as to open in order to avoid a current flow or to close so as to allow a current flow,
wherein the electronic switches are able to be switched, by way of semiconductor-based switching elements, to a high-resistance state of the switching elements so as to avoid a current flow or a low-resistance state of the switching elements so as to allow a current flow,
wherein a respective current sensor unit is provided for each series circuit
in order to respectively ascertain the level of the current in the respective phase conductor,
in particular such that instantaneous current values are present,
wherein provision is made for a control unit that is connected to the current sensor units, the mechanical phase contacts and the electronic switches,
wherein the circuit breaker device is designed such that, in the event of at least one first current threshold value or/and current/time limit value in a phase conductor being exceeded, avoidance of a current flow is initiated, in particular by way of the electronic switches,
wherein a control input is provided on the circuit breaker device,
wherein the circuit breaker device is designed such that the electronic switches are able to be switched to a high-resistance or low-resistance state by way of the control input.

All electronic switches are in particular able to be switched simultaneously to a high-resistance or low-resistance state by the control input.

This has the advantage of providing a control input for a multiphase circuit breaker device using which the electronic switches are able to be switched explicitly. Usually, only the mechanical (phase) contacts are able to be switched using a handle accessible on the circuit breaker device. An external (control input) switching capability for the electronic switches is usually not provided. The invention makes it possible to do this externally and provides a way of enhancing the functions of a circuit breaker device.

Further advantageous embodiments of the invention are specified in the dependent claims and in the exemplary embodiment.

In one advantageous embodiment of the invention, the circuit breaker device is designed such that the electronic switches are able to be switched to a high-resistance or low-resistance state independently of one another by way of the control input.

As an alternative or in addition, for example, each electronic switch may be switched individually (or in pairs) by way of an (in particular configurable) switching sequence; this may in particular be configurable.

This has the particular advantage that a phase-related switching capability (the electronic switches are able to be switched to a high-resistance or low-resistance state independently of one another for each phase) provides for increased flexibility of the circuit breaker device, thereby possibly enabling new functions.

In one advantageous embodiment of the invention, the circuit breaker device is designed such that, in the event of at least one first current threshold value in a phase conductor being exceeded, avoidance of a current flow in the phase conductor in question is initiated, in particular for a first time period, by the electronic switch in question. This has the particular advantage that, in the event of a defined current threshold value or current/time threshold value being exceeded (that is to say the current threshold value is exceeded for a defined duration), only the conductor in question (or the conductors in question) is (or are) selectively interrupted. A current flow is still enabled in the other conductors (unaffected conductors) in a multi-phase low-voltage AC circuit.

The avoidance for a first time period advantageously results in a reactivation or a change to the low-resistance state following the first time period, so as to continue to ensure power supply reliability or so that it is still possible to check for the presence of the exceedance of the current threshold. This may advantageously be performed in particular by evaluating instantaneous values of the level of the current.

This advantageously provides for increased power supply reliability, since it is not full current avoidance that is initiated, but rather only phase-related current avoidance.

It is furthermore possible thereby to intercept brief current peaks and avoid incorrect shutdown when no fault is present in the low-voltage circuit.

In one advantageous embodiment of the invention, the first time period is shorter than 20 ms, in particular shorter than 10 ms.

This has the particular advantage that an interruption takes place for a half wave or full wave of the voltage or current in the AC circuit, in the example (20 ms, 10 ms) with respect to a grid frequency of 50 Hz, such that electrical power supply reliability is restored at the next full wave or half wave. In particular following an interruption, the change to the low-resistance state may take place in the region of the next zero crossing (at the zero crossing or in the region of 1 ms before or after it).

In one advantageous embodiment of the invention, the mechanical phase contacts are assigned to the load-side connection and the electronic switches are assigned to the grid-side connection. The mechanical phase contacts are in particular able to be operated using a mechanical handle in order to switch between opening the contacts or closing the contacts.

The mechanical phase contacts are in particular part of a mechanical isolating contact unit that switches the phase contacts together.

This has the particular advantage of providing a structure for a circuit breaker device that provides for a functionality of the circuit breaker device even when the contacts of the mechanical isolating contact unit are open. This thus provides an advantageous design that assists phase-related switching of the electronic switches, and enables a self-test (in particular a self-test of the electronic switches), even when the contacts are open. This also ensures a power supply for the circuit breaker device, even when the contacts are open.

There is also in particular the advantage of at the same time achieving complete galvanic isolation of all phase conductors (in contrast to a phase-related current flow-avoiding change of the electronic switches to the high-resistance state). The handle enables compatible behavior in accordance with conventional electromechanical circuit breaker devices.

In one advantageous embodiment of the invention, the control input has in particular safe galvanic isolation, in particular between the control input and the phase conductors, more specifically between the control input and the low-voltage circuit (voltage, in the device, of the low-voltage circuit).

Furthermore, more specifically, it has in particular safe galvanic isolation between the control input and the control unit.

Safe galvanic isolation may be implemented for example by way of an optocoupler or relay, or alternatively by inductive or capacitive galvanic isolation.

This has the particular advantage that the control input is able to be used universally at a floating potential or of providing safe galvanic isolation with respect to the phase conductors (or with respect to the control unit). Since the phase conductors (or the control unit) are at grid voltage (for example 230 V (AC)) during operation, this galvanic isolation enables safe use of the control input. This in particular enables protection against an electric shock or so-called “accidental energization” of a connected electrical line and the devices connected thereto. In the event of accidental energization, an electrical potential is unintentionally transferred to an electrical line or another device.

This has the particular advantage that the circuit breaker device is able to be used universally at a floating potential or of providing safe galvanic isolation with respect to the phase conductors (or with respect to the control unit).

In one advantageous embodiment of the invention, the electronic switches are able to be switched to a low-resistance state by way of the control input only when an enable condition is present. In particular, in the event of a high-resistance state, brought about by an (in particular external) protective function of the circuit breaker device, of an electronic switch, this electronic switch (alternatively all electronic switches, that is to say the electronic switches) is (or are) not able to be switched to the low-resistance state by the control input (in particular at least not within a first duration following the change to the high-resistance state).

The first duration may be 10 seconds or more.

This has the particular advantage that the basic function of the circuit breaker device—providing protection—is not influenced by the control input, and for example a defective circuit breaker device (no enable condition) is not able to be switched on forcibly using the control input, that is to say the low-voltage circuit is not supplied with power without protection.

Furthermore, in particular in the event of a high-resistance state, brought about by a protective function of the circuit breaker device, of one or more of the electronic switches (for example in the event of/following an exceedance of current and/or current/time limit values), this high-resistance state cannot be modified by the control input, that is to say the low-resistance state is not able to be reactivated forcibly (immediately). As a result, the circuit breaker device, following a protective function, cannot be switched back to the low-resistance state “just like that”.

In one advantageous embodiment of the invention, circuit breaker device-side checking functions that
a) switch an electronic switch that is in the high-resistance state to the low-resistance state for a first time period or (and)
b) switch an electronic switch that is in the low-resistance state to the high-resistance state for a second time period
are not able to be influenced by the control input (that is to say the checking functions are performed independently of the (status of the) control input).

This has the particular advantage that checking functions of the circuit breaker device are not influenced by the control input, and thus of ensuring functional reliability, in particular provided by checking functions (during operation) of the circuit breaker device.

The first time period is for example a short time period in the range of μs or ms up to one second, such as for example 100 μs . . . 200 μs . . . 300 μs . . . 600 μs . . . 700 μs . . . 800 μs . . . 1 ms 10 ms . . . 20 ms . . . 40 ms . . . 50 ms . . . 100 ms . . . 200 ms . . . 500 ms . . . 1 s (any intermediate value possible).

The second time period is for example a short time period in the range of us or ms up to one second, such as for example 100 μs . . . 200 μs . . . 300 μs . . . 600 μs . . . 700 μs . . . 800 μs . . . 1 ms . . . 10 ms . . . 20 ms . . . 40 ms . . . 50 ms . . . 100 ms . . . 200 ms 500 ms . . . 1 s (any intermediate value possible).

In one advantageous embodiment of the invention, the phase contacts are able to be opened by way of the control input, it being able to be configured in particular whether the control input is able to be used
a) to switch the electronic switches to a high-resistance or low-resistance state or
b) to open the phase contacts (possibly of the mechanical isolating contact unit).

As an alternative or in addition, both one and the other state may be further initiated for example by an (in particular configurable) switching sequence; this may in particular be configurable.

This has the particular advantage of providing further flexibility and a functional enhancement of the circuit breaker device.

In one advantageous embodiment of the invention, the control input is accessible on the housing side. The control input in particular has multiple connection terminals, in particular two, three or four connection terminals, wherein the connection terminals are connected, inside the circuit breaker device, to at least one optocoupler.

This control input also provides a wired interface (in particular a two-wire/three-wire or four-wire wired communication interface), so as to provide virtually delay-free signaling by way of the control input (as far as possible latency-free). Virtually delay-free is understood to mean direct signaling, that is to say without overhead information processing, as occurs for example in principle in the case of LAN/WLAN connections, due to communication protocols, which use for example MAC addresses, TCP/IP communication or OSI communication.

This has the particular advantage of providing a simple way of connecting the control input.

Furthermore, for example, in the case of four connection terminals, each electronic switch is able to be switched independently (and directly), which is advantageous for example in a three-phase AC circuit (as a widespread variant of a multiphase low-voltage AC circuit).

In one advantageous embodiment of the invention, provision is made for a display unit that is connected to the control unit and that has display means, visible on the circuit breaker device, for displaying the high-resistance or low-resistance state of the electronic switches.

In this case, the state of each electronic switch may be displayed. As an alternative, a sum state (high-resistance/low-resistance state) of the electronic switches, which is displayed in accordance with defined criteria or, when the electronic switches are switched together (only a sum state: high-resistance or low-resistance state), only a common state may be displayed.

This has the particular advantage of providing visualization of the state of the electronic switches (or their common switching state).

In one advantageous embodiment of the invention, the circuit breaker device is designed such that, in the event of a (change to the) standby state, initiated by the control input, in which all electronic switches are in the high-resistance state (with the contacts closed), this high-resistance state is established at the current zero crossing of the current in the respective electronic switch. In other words, in the case of for example a three-phase AC circuit comprising for example resistive loads, this takes place in succession (120° phase shift) at the respective current zero crossing.

At the current zero crossing (=in the region of the current zero crossing) means directly at the current zero crossing or close thereto, for example at an instantaneous value of the current that is smaller than a first current limit, for example smaller than 5 amperes . . . 1 ampere (any intermediate value possible; the first current limit depends on the nominal current of the low-voltage circuit or circuit breaker device, for example 20% . . . 15% . . . 10% . . . 5% . . . 1% or less of the nominal current).

This has the particular advantage of supporting switching at virtually zero current and thus of reducing the load on the electronic switches, in particular their semiconductor-based switching elements.

In one advantageous embodiment of the invention, a grid-side neutral conductor connection and a load-side neutral conductor connection are provided on the housing for a neutral conductor of the multiphase low-voltage AC circuit.

The grid-side neutral conductor connection is connected to the load-side neutral conductor connection directly or via a mechanical neutral conductor contact.

This has the particular advantage of providing a multi-pole circuit breaker device in which the neutral conductor is also possibly galvanically interrupted.

In one advantageous embodiment of the invention, the mechanical neutral conductor contact is able to be opened or closed together with the phase contacts. In particular, the neutral conductor contact is closed before the phase contacts are closed or the neutral conductor contact is opened after the phase contacts have been opened.

This has the particular advantage that the neutral conductor contact always opens and closes at zero current. This reduces the wear of the contact and increases service life. This also avoids the occurrence of an arc when the neutral conductor contact is opened.

In one advantageous embodiment of the invention, a respective voltage sensor unit is provided between each phase conductor and the neutral conductor in order to ascertain the level of the voltage between the respective phase conductor and neutral conductor; in particular instantaneous voltage values are present. The voltage sensor units are connected to the control unit.

In one advantageous development of the embodiment, the circuit breaker device is designed such that, in the event of a change to the low-resistance state, initiated by the control unit, in particular the control input (in particular in the absence of an overcurrent event, that is to say when the first or a second current threshold value is not exceeded; for example in the event of a change to the low-resistance state initiated by a user using the control input), of the (all) electronic switches, these change to the low-resistance state, in particular in succession, at the respective zero crossing of the voltage (that is to say at a voltage that is less than 50 V, 25 V, in particular less than 10 V).

An (in particular initiated) low-resistance state of the (all) electronic switches (with the contacts closed (at the same time/simultaneously)) is also referred to as an on state.

This has the particular advantage of reducing repercussions on the grid and the shutdown load in the switch being lower, and of further switching at virtually zero power being assisted, and thus of reducing the load on the electronic switches, in particular their semiconductor-based switching elements.

At the voltage zero crossing (=in the region of the voltage zero crossing) means directly at the voltage zero crossing or close thereto, that is to say for example at an instantaneous value of the voltage that is less than a first voltage limit, for example less than 10 volts, 25 volts or 50 volts (any intermediate value or smaller value is possible).

In one advantageous embodiment of the invention, the circuit breaker device is designed such that, in the event of a change to the high-resistance state, initiated by the control unit, in particular the control input (in particular in the absence of an overcurrent event, that is to say when the first or second current threshold value is not exceeded; for example in the event of a change to the high-resistance state initiated by a user using the control input), of the (all) electronic switches, these change to the high-resistance state, in particular in succession, at the respective zero crossing of the voltage (or at a voltage that is less than 50 V, 25 V, in particular less than 10 V).

An (in particular initiated) high-resistance state of the (all) electronic switches (with the contacts closed (at the same time/simultaneously)) is also referred to as a standby state.

An open state of the mechanical contacts (when the electronic switches are in particular in the high-resistance state) is also referred to as an off state.

This has the particular advantage of reducing repercussions on the grid and the shutdown load in the switch being lower, and of further switching at virtually zero power being assisted, and thus of reducing the load on the electronic switches, in particular their semiconductor-based switching elements.

At the voltage zero crossing means directly at the voltage zero crossing or close thereto, that is to say for example at an instantaneous value of the voltage that is less than a first voltage limit, for example less than 10 volts, 25 volts or 50 volts (any intermediate value or smaller value is possible).

In one advantageous embodiment of the invention, the circuit breaker device is designed such that, in the event of the first current threshold value in a conductor being exceeded, avoidance of a current flow in the conductor in question is initiated by the electronic switch in question. At the next zero crossing of the voltage or the one after that, the electronic switch returns to the low-resistance state in order to enable a current flow. The control unit is in this case connected to the current sensor units, the voltage sensor units, the mechanical (phase) contacts and the electronic switches.

This has the particular advantage of achieving increased robustness against incorrect tripping and thus achieves increased electrical power supply reliability.

In one advantageous embodiment of the invention, the circuit breaker device is designed such that the control input:
a) in the event of an applied first voltage level, initiates the change of the one or more electronic switches to the high-resistance state or, in the event of an applied second voltage level, initiates the change of the one or more electronic switches to the low-resistance state or
b) initiates the state change between the high-resistance or low-resistance state or the low-resistance or high-resistance state of the one or more electronic switches by way of a third voltage level that is applied for a first duration or
c) initiates a change of the one or more electronic switches to the low-resistance state by way of a third voltage level that is applied for a second duration and, following an in particular settable third duration, changes the one or more electronic switches to the high-resistance state.

This has the particular advantage that there are different switching topologies that are advantageously able to be configured, for example.

A voltage level is understood to mean in particular a voltage range, such as for example (low-voltage) TTL voltage levels with voltage ranges such as for example 0 volts to 0.8 volts for a first voltage level (logic zero) and 2 volts to 3.3 volts for a second voltage level (logic one).

In one advantageous embodiment of the invention, the circuit breaker device is designed such that the control input is used to acknowledge a fault-induced high-resistance state of at least one electronic switch, in particular that the fault-induced high-resistance state has been initiated by the exceedance of current or/and current/time limit values in the low-voltage circuit,
such that the electronic switches are able to be switched to the low-resistance state or switch automatically to the low-resistance state when the fault is subsequently no longer present,
it in particular being configurable whether the control input is able to be used
a) to switch the electronic switches to a high-resistance or low-resistance state or
b) to acknowledge a fault-induced high-resistance state.

This has the particular advantage of providing a further functionality of the circuit breaker device.

According to the invention, what is claimed is a corresponding method for a circuit breaker device for a multi-phase low-voltage AC circuit having electronic (semiconductor-based) switches, having the same and further advantages.

The method for a circuit breaker device for protecting an electrical multiphase low-voltage AC circuit having:
a housing having grid-side phase connections and load-side phase connections for phase conductors of the low-voltage AC circuit,
series circuits consisting of a mechanical phase contact and an electronic switch,
wherein a respective series circuit electrically connects one of the grid-side phase connections to one of the load-side phase connections,
wherein the mechanical phase contacts are able to be switched together so as to open in order to avoid a current flow or to close so as to allow a current flow,
wherein the electronic switches are able to be switched, by way of semiconductor-based switching elements, to a high-resistance state of the switching elements so as to avoid a current flow or a low-resistance state of the switching elements so as to allow a current flow,
wherein the level of the current in the respective phase conductor is ascertained in each series circuit, in particular in such a way that instantaneous current values are present,
wherein, in the event of at least one first current threshold value or current/time limit value in a phase conductor being exceeded, avoidance of a current flow is initiated, in particular by the electronic switches,
wherein the electronic switches are able to be switched to a high-resistance or low-resistance state by way of a control input.

In one advantageous embodiment, the electronic switches are switched to a low-resistance state by way of the control input only when an enable condition is present. In particular, in the event of a high-resistance state, brought about by a protective function of the circuit breaker device, of an electronic switch, the electronic switches are not able to be switched to the low-resistance state using the control input.

In one advantageous embodiment, circuit breaker device-side checking functions that
a) switch an electronic switch that is in the high-resistance state to the low-resistance state for a first time period or (and)
b) switch an electronic switch that is in the low-resistance state to the high-resistance state for a second time period
are not influenced by the control input.

All embodiments, both in dependent form referring back to patent claims 1 and 20 and referring back only to individual features or combinations of features of patent claims, in particular including a back-reference in the dependent arrangement claims to the independent method claim (and vice versa), bring about an improvement to a circuit breaker device, in particular an improvement in functionality, and provide a novel feature and concept for a circuit breaker device.

The described properties, features and advantages of this invention and the way in which these are achieved will become clearer and more clearly comprehensible in connection with the following description of the exemplary embodiments, which are explained in more detail in connection with the drawing.

Here, in the drawing:

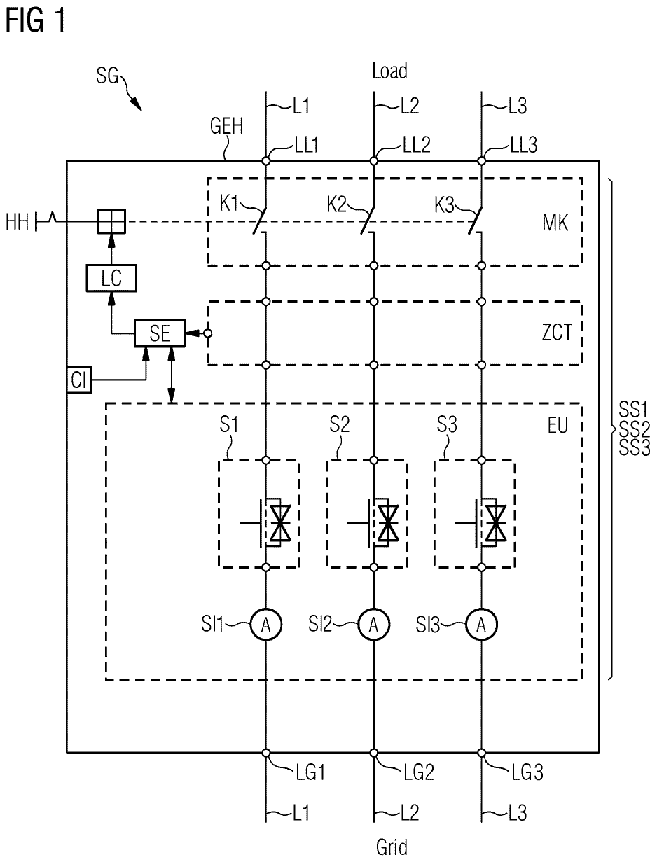

FIG. 1 shows a first illustration of a circuit breaker device,

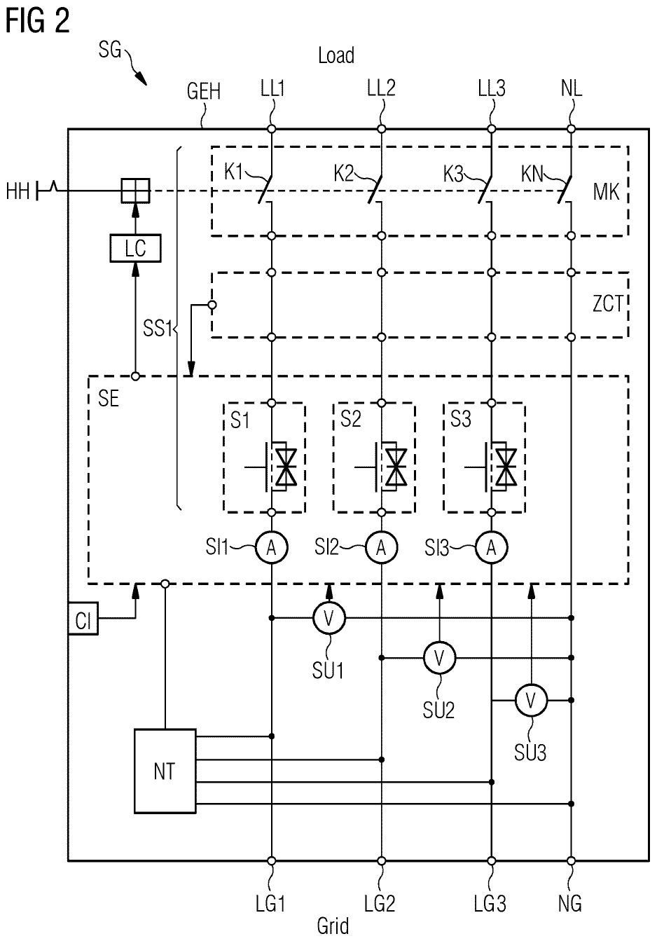

FIG. 2 shows a second illustration of a circuit breaker device,

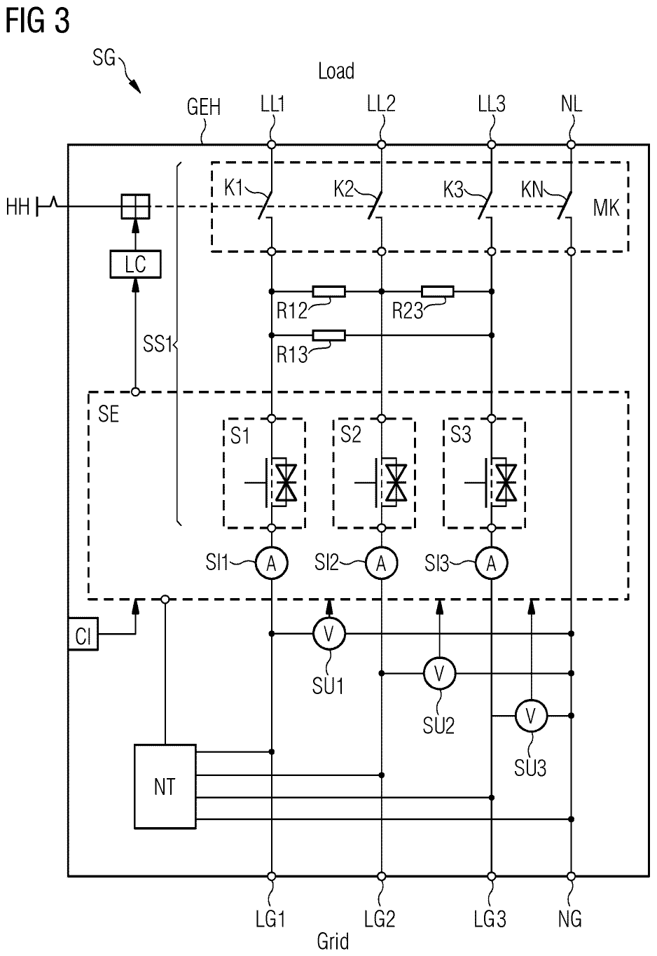

FIG. 3 shows a third illustration of a circuit breaker device,

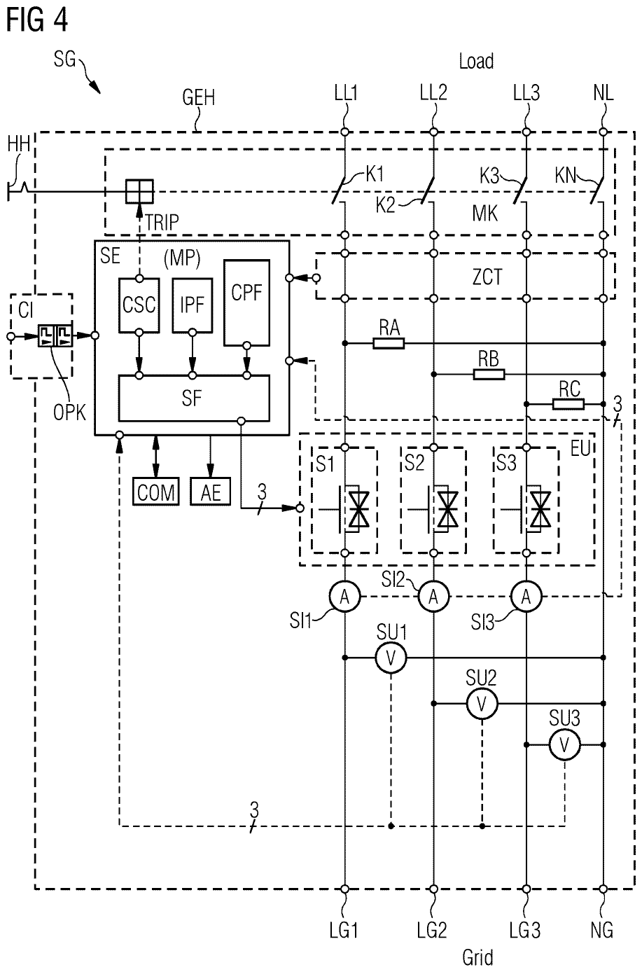

FIG. 4 shows a fourth illustration of a circuit breaker device,

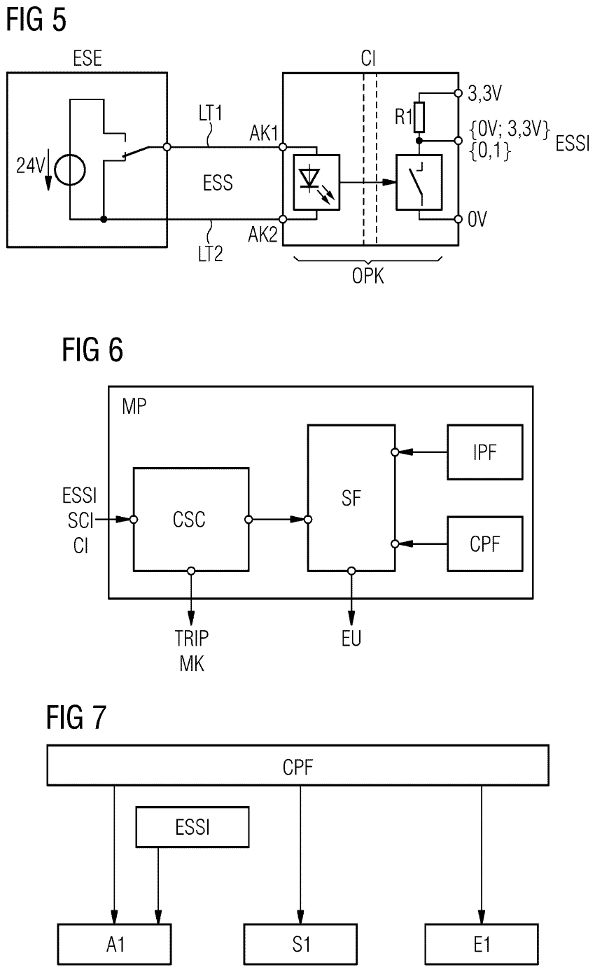

FIG. 5 shows an illustration of a control input,

FIG. 6 shows an illustration of a function group,

FIG. 7 shows an illustration of a first configuration,

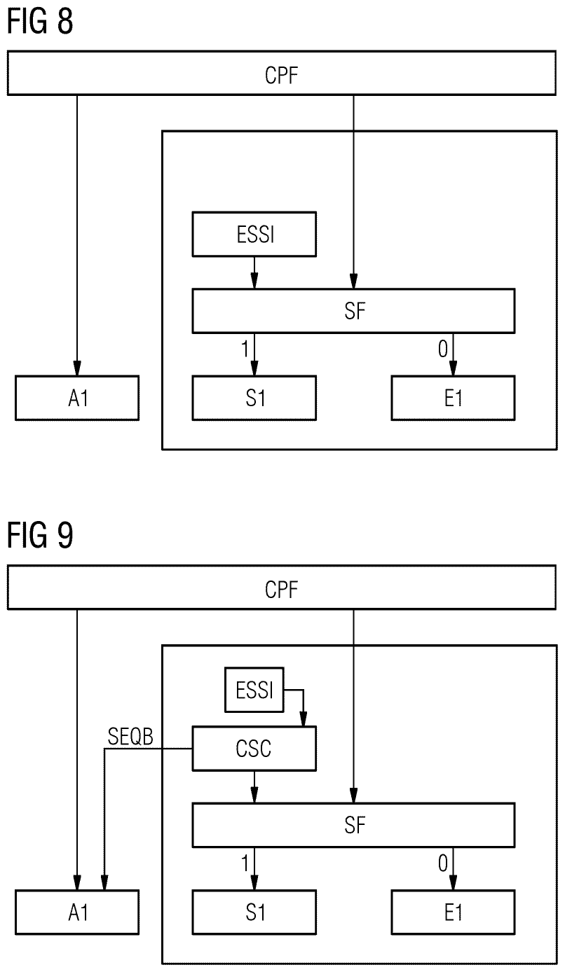

FIG. 8 shows an illustration of a second configuration,

FIG. 9 shows an illustration of a third configuration,

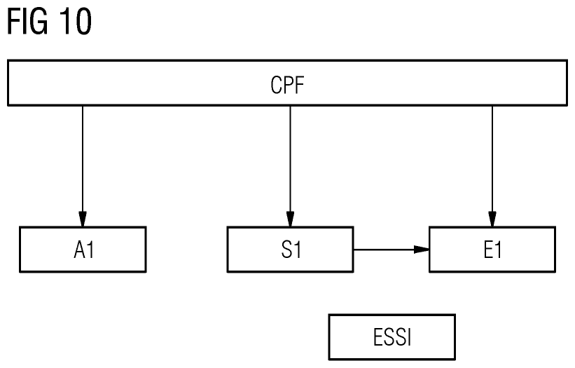

FIG. 10 shows an illustration of a fourth configuration.

FIG. 1 shows an exemplary illustration of a 3-pole, for example for 3 phase conductors, circuit breaker device SG for protecting an electrical multiphase low-voltage AC circuit, in the example according to FIG. 1 a three-phase low-voltage AC circuit, having:
a housing GEH having a first, second and third grid-side phase connection LG1, LG2, LG3 and a first, second and third load-side phase connection LL1, LL2, LL3, for the first, second and third phase conductors L1, L2, L3 of the low-voltage AC circuit,
a power source is usually connected on the grid side Grid, a consumer is usually connected on the load side Load.

In the housing GEH:
a first series circuit SS1 consisting of a first mechanical phase contact K1 and a first electronic switch S1, a second series circuit SS2 consisting of a second mechanical phase contact K2 and a second electronic switch S2, a third series circuit SS3 consisting of a third mechanical phase contact K3 and a third electronic switch S3,
wherein:
the first series circuit SS1 electrically connects the first grid-side phase connection LG1 to the first load-side phase connection LL1,
the second series circuit SS2 electrically connects the second grid-side phase connection LG2 to the second load-side phase connection LL2 and
the third series connection SS3 electrically connects the third grid-side phase connection LG3 to the third load-side phase connection LL3,
the mechanical phase contacts K1, K2, K3 are able to be switched together, that is to say are opened together in order to avoid a current flow or are closed together so as to allow a current flow, that is to say the mechanical contacts are connected to one another via mechanical coupling (for example a switching shaft),
the electronic switches S1, S2, S3 are able to be switched, by way of semiconductor-based switching elements, to a high-resistance state of the switching elements so as to avoid a current flow or a low-resistance state of the switching elements so as to allow a current flow.

According to the invention, a control input CI is provided on the circuit breaker device SG. The circuit breaker device SG is designed such that the electronic switches S1, S2, S3 are able to be switched to a high-resistance or low-resistance state by way of the control input CI.

In particular (in one simple variant), all of the electronic switches S1, S2, S3 are able to be switched to the high-resistance or low-resistance state simultaneously by the control input CI.

According to FIG. 1, provision is made for a first, second and third current sensor unit SI1, SI2, SI3. The first current sensor unit SI1 is provided or arranged in the first series circuit SS1, the second current sensor unit SI2 is provided or arranged in the second series circuit SS2 and the third current sensor unit SI3 is provided or arranged in the third series circuit ss3 in order to respectively ascertain the level of the current in the first, second and third phase conductor L1, L2, L3, in particular such that instantaneous current values are present.

The first mechanical phase contact K1, the second mechanical phase contact K2 and the third mechanical phase contact K3 are, according to FIG. 1, part of a mechanical isolating contact unit MK that opens or closes the phase contacts K1, K2, K3 together. The mechanical isolating contact unit MK may have a handle HH accessible on the circuit breaker device for manually (actuated by a person) opening or closing the phase contacts. The mechanical isolating contact unit MK corresponds for example to a conventional unit as known from electromechanical circuit breaker devices (miniature circuit breakers, power circuit breakers) (but, according to the invention, without overcurrent or short-circuit detection elements, such as bimetal tripping devices, etc.).

The circuit breaker device is in particular designed such that the mechanical phase contacts or the mechanical isolating contact unit MK are able to be opened, but not closed, by a control unit SE. In particular, it is possible to close the mechanical contacts using the handle HH only after an enable provided by the control unit SE. For this purpose, provision may be made for an enable unit LC. In other words, the contacts are able to be closed using the handle HH only when an enable or enable signal (from the control unit) is present. Without the enable or the enable signal, although the handle HH is able to be actuated, the contacts are not able to be closed (permanent slider contacts). The enable unit LC may furthermore be designed such that it is possible to open the contacts K1, K2, K3 of the mechanical isolating contact unit MK by way of a control signal from the control unit SE, as indicated in FIG. 1 by an arrow from the control unit SE to the enable unit LC.

According to FIG. 1, the mechanical phase contacts K1, K2, K3 are assigned to the load-side phase connections/the load side Load and the electronic switches S1, S2, S3 are assigned to the grid-side phase connections/grid side Grid.

The first electronic switch S1, the second electronic switch S2 and the third electronic switch S3 may be part of an electronic interruption unit EU, wherein the electronic switches S1, S2, S3 are in particular able to be switched independently of one another.

The electronic interruption unit/the electronic switches may have bidirectional dielectric strength. Specifically, overvoltage protection is provided for the semiconductor-based switching elements in order to limit the voltages and thus to have protection for the semiconductor-based switching elements.

Provision is made for a control unit SE (as already mentioned in part) that is connected to the current sensor units SI1, SI2, SI3, the mechanical phase contacts (K1, K2, K3) or the mechanical isolating contact unit MK (as illustrated in FIG. 1) and the electronic switches S1, S2, S3. The control input CI is connected to the control unit SE, as illustrated by way of example in FIG. 1.

The current sensor units SI1, SI2, SI3 each ascertain the level of the current in their respective (phase) conductor, such that in particular instantaneous values of the current are present.

In the event of at least one first current threshold value or current/time limit value in a (at least one) conductor being exceeded, avoidance of a current flow is initiated.

In one variant, the current flow may be avoided in the conductor in question (in which the first current threshold value or current/time limit value has been exceeded). In another variant, the current flow may be avoided in all phase conductors (or alternatively in all conductors in which an electronic switch is provided). The current flow is avoided in particular by changing the electronic switch or electronic switches (depending on the configuration) to the high-resistance state. In the event of at least one second (higher) current threshold value or current/time limit value (higher or longer current/time value compared to the first current/time limit value) in a (at least one) conductor being exceeded, a current flow may be avoided by opening the contacts K1, K2, K3.

The change to the high-resistance state may in particular take place for a first time period. Following the time period, the electronic switch in question (or the electronic switches in question) may return to the low-resistance state. Overcurrent events (exceedance of current threshold value) may be dealt with for each phase/phase conductor.

The electronic switches are thus also protected against an overload.

The change to the low-resistance state may in particular take place at the next zero crossing or before or after the zero crossing of the voltage. (All 3 options: at the zero crossing, before the zero crossing or after the zero crossing—are possible, or in the event of an absolute value of a voltage threshold, in particular 50 V, 25 V or 10 V, being fallen below.)

The first time period may in particular be less than 20 ms, especially less than 10 ms.

Provision may be made for a differential current sensor unit ZCT, as illustrated in FIG. 1, for recording differential currents in the low-voltage AC circuit, as is known for example from fault current circuit breakers. The differential current sensor unit ZCT is connected to the control unit SE.

The current sensor units SI1, SI2, SI3, in the example according to FIG. 1, are arranged between grid-side connections LG1, LG2, LG3 of the series circuit consisting of the electronic switch S1, S2 S3 and the mechanical phase contacts K1, K2, K3, specifically between grid-side connections LG1, LG2, LG3 and the electronic switches S1, S2, S3.

The current sensor units SI1, SI2, SI3 may also be arranged elsewhere, for example between electronic switches S1, S2, S3 and mechanical phase contacts K1, K2, K3.

The first, second and third electronic switch may be able to be switched to a high-resistance or low-resistance state independently of one another. In other words, the first, second and third electronic switch are switched to a high-resistance or low-resistance state independently of one another, in particular in order to avoid or enable a phase conductor-dependent current flow. In one embodiment of the invention, the electronic switches are able to be switched to the high-resistance or low-resistance state independently of one another by way of the control input CI.

FIG. 2 shows an illustration according to FIG. 1, with the following differences.

Provision is made for a grid-side neutral conductor connection NG and a load-side neutral conductor connection NL for a neutral conductor N of the multiphase low-voltage AC circuit, in the example according to FIG. 2 a three-phase low-voltage AC circuit with a neutral conductor. According to FIG. 2, the grid-side neutral conductor connection NG is connected to the load-side neutral conduction connector NL via a neutral conductor contact KN.

As an alternative, the grid-side neutral conductor connection NG may also be connected to the load-side neutral conductor connection NL directly (that is to say without a switchable contact).

In this example, an electronic switch is not provided in the neutral conductor path in the housing of the circuit breaker device. In other words, the neutral conductor connection between the grid-side neutral conductor connection NG and the load-side neutral conductor connection NL is free from electronic switches (electronic switch-free).

The mechanical neutral conductor contact KN may advantageously be switched together with the phase contacts K1, K2, K3. In other words, the mechanical neutral conductor contact KN is able to be opened or closed together with the phase contacts K1, K2, K3, as explained further above for the contacts K1, K2, K3.

Specifically, the mechanical isolating contact unit MK May be designed such that the neutral conductor contact KN is closed before the phase contacts K1, K2, K3 are closed.

In the same way, the neutral conductor contact KN may be opened after the phase contacts K1, K2, K3 have been opened.

Provision is furthermore made for a power supply NT, such as for example a power supply unit, for supplying power to the circuit breaker device SG, in particular the control unit SE.

The power supply NT in the example is connected, on the one hand, to the phase conductors L1, L2, L3 and (where applicable) the neutral conductor N. However, it may also be connected to only some of the conductors (at least two) in order to supply power. The power supply NT in the example is also connected to the control unit SE.

The control unit SE is also combined with the electronic switches S1, S2, S3 and the current sensor units SI1, SI2, SI3, as illustrated in FIG. 2.

Furthermore, a respective voltage sensor unit is provided between each phase conductor and the neutral conductor. A first voltage sensor unit SU1 is provided between the first phase conductor L1 and the neutral conductor N, a second voltage sensor unit SU2 is provided between the second phase conductor L2 and the neutral conductor N and a third voltage sensor unit SU3 is provided between the third phase conductor L3 and the neutral conductor N, in order to ascertain the level of the voltage between the respective phase conductor and neutral conductor, in particular such that instantaneous voltage values are present. The voltage sensor units SU1, SU2 and SU3 are connected to the control unit SE.

In the event of a change to the low-resistance state, initiated by the control unit SE, in particular by the control input CI, of the electronic switches S1, S2, S3, for example:
in the event of a change to the low-resistance state initiated by a user (for example on the device or using the control input) or
in the event of a change to the low-resistance state initiated by the circuit breaker device, specifically in the absence of an overcurrent event (that is to say when the first or second current threshold value is not exceeded), for example when an internal checking function of (for internally checking) the circuit breaker device initiates a change to the low-resistance state,
=> the electronic switches may advantageously change to the low-resistance state in succession at the respective zero crossing of the voltage.

In the event of a change to the high-resistance state, initiated by the control unit SE, in particular by the control input CI, of the electronic switches S1, S2, S3, 8 for example:
in the event of a change to the high-resistance state initiated by a user (for example on the device or using the control input) or
in the event of a change to the high-resistance state initiated by the circuit breaker device, specifically in the absence of an overcurrent event (that is to say when the first or second current threshold value is not exceeded), for example when an internal checking function of (for internally checking) the circuit breaker device initiates a change to the high-resistance state,
=> the electronic switches may advantageously change to the high-resistance state in succession at the respective zero crossing of the voltage (=in the region of the zero crossing).

As an alternative or in addition to using the voltage, the circuit breaker device may be designed such that, in the event of an initiated standby state, in which all electronic switches (S1, S2, S3) are in the high-resistance state (or are intended to transition to the high-resistance state), this high-resistance state is established by the respective electronic switch at the current zero crossing of the current in the respective conductor (in particular when a current is flowing in the phase conductors).

The voltage sensor units SU1, SU2, SU3, as already mentioned, are connected to the control unit SE, which is also connected to the current sensor units SI1, SI2, SI3, the mechanical phase contacts K1, K2, K3 (or mechanical isolating contact unit MK), the electronic switches S1, S2, S3 and the control input CI. The circuit breaker device SG May furthermore advantageously be designed such that, in the event of at least one first current threshold value (specifically instantaneous value of the current) in a conductor being exceeded, avoidance of a current flow in the conductor in question is initiated by the electronic switch in question. At the next zero crossing of the voltage or the one after that (in the region of the zero crossing), the electronic switch returns to the low-resistance state in order to enable a current flow.

This may take place several times until a first number of repetitions has been exceeded. Then:
a) all electronic switches may change to the high-resistance state, or (/and)
b) the contacts may be opened (galvanic isolation).

Any desired combinations (intermediate combinations) from the illustrations of the exemplary circuit breaker devices according to FIGS. 1 and 2 are possible (for example power supply NT from FIG. 2 in FIG. 1, etc.).

FIG. 3 shows an illustration according to FIG. 2, with the difference that measurement resistors R12, R13, R23 are provided between the phase conductors within the circuit breaker device.

For this purpose, in one embodiment, a first measurement resistor (or measurement impedance) R12 is provided between the first phase conductor L1 and the second phase conductor L2, a second measurement resistor (or measurement impedance) R23 is provided between the second phase conductor L2 and the third phase conductor L3, and a third measurement resistor (or measurement impedance) R13 is provided between the first phase conductor L1 and the third phase conductor L3.

It is thus possible, in particular even in the absence of a neutral conductor (3-pole circuit breaker device), to check the switching behavior of the electronic switches S1, S2, S3 by way of the measurement resistors (which may also be implemented as measurement impedances, that is to say for example as combinations of resistors/capacitors or/and inductors), for example by briefly switching on (μs, ms or shorter second range) the electronic switches while the contacts are open, wherein a measurement current corresponding to the measurement resistor (measurement impedance) is provided and able to be checked (at respective instantaneous values of the voltage).

In the case of a 4-pole device, that is to say for example for a three-phase AC circuit with a neutral conductor, the measurement resistors may (alternatively) also be provided between phase conductor and neutral conductor.

The (optional) differential current sensor unit ZCT is not provided in this example (but could just as well be provided).

A high-resistance state is understood to mean a state in which only a current of negligible magnitude flows. High-resistance resistance values are in particular understood to mean those greater than 1 kiloohm, better still greater than 10 kiloohms, 100 kiloohms, 1 megaohm, 10 megaohms, 100 megaohms, 1 gigaohm or more.

A low-resistance state is understood to mean a state in which the current value indicated on the circuit breaker device could flow. Low-resistance resistance values are in particular understood to mean those less than 10 ohms, better still less than 1 ohm, 100 milliohms, 10 milliohms, 1 milliohm or less.

The electronic switches S1, S2, S3 or the electronic interruption unit EU may have semiconductor components such as bipolar transistors, field-effect transistors (FET), insulated-gate bipolar transistors (IGBT), metal-oxide-semiconductor field-effect transistors (MOSFET) or other (self-controlled) power semiconductors. IGBTs and MOSFETs, due to their low flow resistances, high blocking-layer resistances and good switching behavior, are particularly suitable for the electronic switches (as semiconductor-based switching elements).

The circuit breaker device according to the invention thus contains electronic and mechanical components. Arranging all of the required components sensibly for safe operation is one aspect. The combination of electronic switch and mechanical contacts also enables multiple switching combinations.

In the example, the circuit breaker device has in each case three grid-side and three load-side connections/four grid-side and four load-side connections. The device in the example contains a 3-pole or 4-pole mechanical isolating con-tact unit (isolating contact system). The contacts are coupled mechanically to one another and are only able to be opened or closed together.

The phase conductors contain an electronic switch in series with the mechanical contact. These switches, unlike the mechanical contacts, are switched on and off in particular independently of one another (in one simple variant, switching of all electronic switches is initiated by the control unit—wherein the electronic switches themselves are able to switch at zero crossings of the voltage or current). A current sensor unit is also provided in the phase conductors (not in the neutral conductor N).

Mechanical contacts or a mechanical isolating contact unit MK are understood to mean in particular a (standard-compliant) isolating function, performed by the isolating contact unit MK. Isolating function is understood to mean the following points:
minimum clearance in air according to standards (minimum distance between the contacts),
contact position indication for the contacts of the mechanical isolating contact unit,
actuation/interruption of the contacts of the mechanical isolating contact unit (by way of the control unit) is always possible ((permanent) blocking of the contacts in the closed state by the handle is not possible).

With regard to the minimum clearance in air between the contacts of the isolating contact unit, this is essentially voltage-dependent. Other parameters are the pollution degree, the type of field (homogeneous, inhomogeneous) and air pressure or height above sea level.

There are corresponding rules or standards for these minimum clearances in air or creepage paths. These rules stipulate for example, in the case of air for a surge withstand capability, the minimum clearance in air for an inhomogeneous and a homogeneous (ideal) electric field on the basis of the pollution degree. The surge withstand capability is the withstand capability when a corresponding surge voltage is applied. The isolating contact unit or circuit breaker device has an isolating function (isolator property) only in the presence of this minimum length (minimum clearance in air).

Within the scope of the invention, the DIN EN 60947 and IEC 60947 series of standards are relevant to the isolator function and the properties thereof in this case, to which standards reference is made here.

The isolating contact unit is advantageously characterized by a minimum clearance in air between the open isolating contacts in the OFF position (open position, open contacts) on the basis of the rated impulse withstand voltage and the pollution degree. The minimum clearance in air is in particular between (at least) 0.01 mm and 14 mm. The minimum clearance in air is in particular advantageously between 0.01 mm at 0.33 kV and 14 mm at 12 kV, in particular for pollution degree 1 and in particular for inhomogeneous fields.

Advantageously, the minimum clearance in air may have the following values:

TABLE 13
Minimum clearances in air

| | Minimum clearances | | | | | | | |
|---|---|---|---|---|---|---|---|---|
| Rated | mm | | | | | | | |
| impulse | Case A | | | | Case B | | | |
| withstand | Inhomogeneous field conditions | | | | Homogeneous field ideal conditions | | | |
| voltage | (see 3.7.63) | | | | (see 3.7.62) | | | |
| Uᵢₘₚ | Pollution degree | | | | Pollution degree | | | |
| kV | 1 | 2 | 3 | 4 | 1 | 2 | 3 | 4 |
| 0.33 | 0.01 | 0.2 | 0.8 | 1.6 | 0.01 | 0.2 | 0.8 | 1.6 |
| 0.5 | 0.04 | | | | 0.04 | | | |
| 0.8 | 0.1 | | | | 0.1 | | | |
| 1.5 | 0.5 | 0.5 | | | 0.3 | 0.3 | | |
| 2.5 | 1.5 | 1.5 | 1.5 | | 0.6 | 0.6 | | |
| 4.0 | 3 | 3 | 3 | 3 | 1.2 | 1.2 | 1.2 | |
| 6.0 | 5.5 | 5.5 | 5.5 | 5.5 | 2 | 2 | 2 | 2 |
| 8.0 | 8 | 8 | 8 | 8 | 3 | 3 | 3 | 3 |
| 12 | 14 | 14 | 14 | 14 | 4.5 | 4.5 | 4.5 | 4.5 |

NOTE
The values of minimum clearance in air are based on 1.2/50 μs impulse voltage, for barometric pressure of 80 kPa, equivalent to normal atmospheric pressure at 2000 m above sea level.

The pollution degrees and field types correspond to those defined in the standards. This advantageously makes it possible to achieve a standard-compliant circuit breaker device dimensioned in accordance with the rated impulse withstand voltage.

A mechanical isolating contact unit is in particular not understood to mean a relay contact.

FIG. 4 shows an illustration according to FIG. 1, 2 or 3, with the difference that individual units are not illustrated and that the first, second and third measurement resistors R12, R13, R23 are not provided between the phase conductors (FIG. 3). Instead of this, a measurement resistor is provided in each case between a phase conductor and the neutral conductor. For this purpose, a fourth measurement resistor RA (or measurement impedance) is provided between the first phase conductor L1 and the neutral conductor N, a fifth measurement resistor RB (or measurement impedance) is provided between the second phase conductor L2 and the neutral conductor N and a sixth measurement resistor RC (or measurement impedance) is provided between the third phase conductor L3 and the neutral conductor N.

It is thus possible to check the switching behavior of the electronic switches S1, S2, S3 using the fourth, fifth and sixth measurement resistors R1, R2, R3 (which may also be implemented as measurement impedances, that is to say for example as combinations of resistors/capacitors or/and inductors), for example by briefly switching on (μs, ms or shorter second range) the electronic switches while the contacts are open, wherein a measurement current corresponding to the measurement resistor (measurement impedance) is provided and able to be checked (at respective instantaneous values of the voltage). This may be carried out by briefly switching on an electronic switch in order to generate a measurement current through the respective measurement resistor between the phase conductor and neutral conductor. As an alternative or in addition, this may also be carried out by briefly switching on two electronic switches in order to generate a measurement current through two phase conductors (two measurement resistors).

FIG. 4 also illustrates further or different units. Provision may be made for an (in particular wireless) communication unit COM that is connected to the control unit SE or is part thereof. Provision may also be made for a display unit AE. The display unit AE may be designed as a combined display and input unit. The display unit AE (display and input unit) may be connected to the control unit SE or be part thereof. The display unit AE has display means, visible on the circuit breaker device, in particular for displaying the high-resistance or low-resistance state of the electronic switches or an overall state of the electronic switches.

According to FIG. 4, the control unit SE may have a microcontroller MP (microcontroller unit). The microcontroller may have various functions or routines/processes, such as
a switching logic function SF,
an internal protective function IPF, for internally checking and reporting that the circuit breaker device is free from faults,
an external protective function CPF, which monitors the multiphase low-voltage AC circuit and for example reports an overcurrent event, short circuit etc. in the low-voltage circuit,
a control signal configuration unit CSC that may be used for example to configure whether the state of the electronic switches (high-resistance/low-resistance) is changed or (also) the mechanical (phase) contacts are opened by an opening signal TRIP.

Said units and functions will be discussed in more detail below.

The circuit breaker device SG operates for example in principle such that, when the contacts of the mechanical isolating contact unit are closed and the interruption unit is in the low-resistance state (on state) and
in the event of an ascertained current that exceeds a first current value, in particular in which the first current value is exceeded for a first time limit, the electronic interruption unit EU changes to the high-resistance state and the mechanical isolating contact unit MK remains closed, or/and
(or/and) in the event of an ascertained current that exceeds a higher second current value, in particular for a second time limit, the electronic interruption unit EU changes to the high-resistance state and the mechanical isolating contact unit MK is opened, or/and
in the event of an ascertained current that exceeds an even higher third current value, the electronic interruption unit changes to the high-resistance state and the mechanical isolating contact unit MK is opened.

The invention will be explained in more detail in partially different words below.

In recent electronic circuit breaker devices, contacts (of a mechanical isolating contact unit) are used in combination with electronic switches/semiconductor-based switching elements (of an electronic interruption unit). The ability to control these switching elements using a (galvanically isolated) control input CI is a recent way of enhancing the functions of the circuit breaker device. At the same time, it is ensured according to the invention that the ability to control the switching elements/the electronic switches does not impair the safety-relevant protective functions of the circuit breaker device.

The control unit SE is able to switch the electronic switches to a high-resistance or low-resistance state, that is to say switch them on and off, and open the contacts (the contact) of the mechanical isolating contact unit. A handle (for opening and closing the isolating contact unit), a current measurement, advantageously a voltage measurement and a power supply are also present. The circuit breaker device may carry out various external protective functions CPF, such as short-circuit protection, overcurrent protection (overload protection), differential fault current protection, fire protection, overvoltage protection, undervoltage protection. It may also carry out various internal protective function IPF, such as excess temperature protection.

Overload protection is for example the exceedance of first current or/and current/time limit values. Short-circuit protection is for example the exceedance of fourth (higher) current or/and current/time limit values. Differential fault current protection is for example the exceedance of differential current limit values (for example 30 mA). Fire protection is for example the detection of serial arcing in the low-voltage circuit. The same applies to overvoltage protection, undervoltage protection and excess temperature protection.

According to the invention, an in particular galvanically isolated control input CI is added. This control input CI may be used to control the switching state of the electronic switches S1, S2, S3. Since the electronic switches are required in particular to carry out external protective functions CPF, the control unit SE forwards a signal from the control input CI for the electronic switches (synonymously: electronic interruption unit EU) to change to the 23 low-resistance state to the electronic switches only when no fault is present from the stored external or internal protective functions CPF, IPF (no fault has been detected), that is to say an enable condition is present. In particular in the event of an identified fault, that is to say when at least one electronic switch is in the high-resistance state, the control input is not able to modify this state (that is to say not switch to the low-resistance state).

In other words, the electronic interruption unit EU is able to be switched to the low-resistance state by way of the control input CI only when an enable condition is present.

In particular, in the event of a high-resistance state, brought about by an external or internal protective function CPF, IPF of the circuit breaker device, of the electronic switches, these are not able to be switched to the low-resistance state by the control input.

An identified internal fault in the circuit breaker device is understood to mean in particular a circuit breaker device fault, such as for example a defective current sensor unit, defective electronic switches, excess temperature.

This may furthermore also be the case for external faults, such as overvoltage or undervoltage (exceed/fall below RMS value of the voltage for a certain time). This may also concern the external protective functions CPF, such that, following the exceedance of current or/and current/time limit values and avoidance of the current flow in the low-voltage circuit, an immediate “forced” change to the low-resistance state is not possible, or not possible immediately, using the control input CI.

The same applies to other internal device functions/circuit breaker device-side checking functions, for example for device diagnostics or inrush handling. In other words, circuit breaker device-side checking functions that
a) switch an electronic switch that is in the high-resistance state to the low-resistance state for a first time period or (and)
b) switch an electronic switch that is in the low-resistance state to the high-resistance state for a second time period
are not able to be influenced by the control input.

These brief switching operations may be used for example to test the electronic switches or to check the functionality of the current sensor unit.

These brief switching operations are prioritized by the control unit SE or the switching logic function SF, such that an (external) control signal ESS at the control input CI is not able to prevent these brief switching operations.

The ability to control the electronic switches, respectively the (where applicable) electronic interruption unit EU (its switching elements), is thus possible by way of the control input CI only when the circuit breaker device is in the fault-free state or/and no fault has been detected in particular at the load-side connection/connections (at the load output) (an enable condition is present). This task is taken on by the switching logic function SF. The control input CI is thus not able to access the electronic switches (or the electronic interruption unit) directly for control purposes, but rather only transmit a signal ESSI to switch the electronic interruption unit on or off to the switching logic function SF. The switching logic function SF ensures that the external and internal protective functions CPF, IPF are always able to act as a priority on the electronic switches (electronic interruption unit).

This is the case not only for the external and internal protective functions CPF, IPF of the circuit breaker device, but also for (in some cases already mentioned) checking functions of the circuit breaker device, which check in particular the ability to switch the electronic switches by switching them on or off for the (brief) first or second time period, for example.

FIG. 5 shows the basic design of a galvanically isolated control input CI in connection with an external control unit ESE.

FIG. 5 shows a control input CI accessible on the housing GEH. It has multiple connection terminals, in the example two connection terminals AK1, AK2, wherein the two connection terminals AK1, AK2 are connected, inside the circuit breaker device, to at least one optocoupler OPK. The optocoupler OPK is also connected, in the example, to the resistor R1, on the one hand, wherein the resistor R1 is connected, on the other hand, to a voltage 3.3 V (in the example positive connection at an internal voltage of 3.3 volts). The connection between the resistor R1 and the optocoupler OPK is accessible {0 V; 3.3 V} {0, 1} and, in the example, delivers an internal control signal ESSI that is equivalent to the external control signal ESS (and is galvanically isolated) for further processing in the circuit breaker device. The connection of the optocoupler OPK on the other side is connected to the other connection of the voltage 0 V (in the example ground connection).

The two connection terminals AK1, AK2 are connected, on the outside of the housing, to a two-wire line, having a first conductor LT1 and a second conductor LT2. The two-wire line is also connected to an external control unit ESE.

The external control unit ESE selectively makes available a voltage signal 24 V, which is used to actuate the optocoupler OPK via the control input CI so as to achieve the (desired) change of the electronic interruption unit to the high-resistance or low-resistance state.

In other words, provision is made for an optocoupler OPK with appropriate galvanic isolation. An external (separate) control unit ESE sends a voltage in order to transmit a control signal ESS.

Instead of the optocoupler, a relay or another galvanic isolation element may also be provided or used, such as for example elements based on parasitic or inductive galvanic isolation.

In the same way, in particular three or four (or more) connection terminals may be provided in order to switch each electronic switch individually via corresponding connection terminals. In this case, provision may be made for a common connection terminal, and the first, second or third electronic switch is then switched in each case via the second, third and fourth connection terminal.

FIG. 6 once again shows the function group for the microcontroller MP. The microcontroller MP has a connection to the control input CI, to which a signal is fed from the control input SCI, ESSI. This signal is fed to a control signal configuration unit CSC. By way of example, it May optionally be configured here that the mechanical contacts (mechanical isolating contact unit MK) are opened, using the control input CI, by an opening signal TRIP (open contact/contacts). The signal from the control input is further fed to the switching logic function SF. The switching logic function is also connected to the protective functions, in the example to the internal protective function IPF, for the internal checking and reporting that the circuit breaker device is free from faults, and the external protective function CPF, which monitors the multiphase low-voltage AC circuit and reports an overcurrent event, short circuit, etc. in the low-voltage circuit.

If the circuit breaker device does not have any internal faults, which is reported by the internal protective function IPF, and there are no external faults in the low-voltage circuit to be protected, which is reported by the external protective function CPF, both reports are given to the switching logic function SF, an enable condition is present and the electronic switches (electronic interruption unit) are able to be switched to a low-resistance or high-resistance state via the control input CI (connection of the switching logic function SF to the electronic interruption unit EU (arrow towards this)).

The switching logic function SF ensures, in the circuit breaker device, that the protective functions IPF, CPF, which relate to the ability to control the electronic switches (electronic interruption unit EU), are always able to switch these safely when required.

If an external protective function CPF becomes active, the one or more electronic switches are not able to be controlled by the control input. If no protective state is active (enable condition), the ability to carry out control via the control input is enabled again for the electronic interruption unit.

The same principle applies for internal device functions/circuit breaker device-side checking functions or internal protective functions IPF. These internal protective functions IPF likewise access the electronic interruption unit. Internal device functions/circuit breaker device-side checking functions that perform for example only a brief switching operation, for example for a device diagnostics function, also access the one or more electronic switches as a priority. If this function is carried out, the ability to carry out control via the control input is not possible for this time. Phases may thus be switched off (change to the high-resistance state) for a brief time, for example for test purposes.

The control signal configuration unit CSC may be used to configure what is done/supposed to be done with the (digital) control signal.

By way of example, the electronic switches (electronic interruption unit EU) may be driven, or the mechanical contacts (mechanical isolating contact unit) may be driven, or both.

This may be achieved using different levels of the external control signal ESS, time offsets or sequences.

Examples of the parameterization and configuration are explained in detail below.

### 1.) Simple Switching On/Off

Electronic switches are in the low-resistance state when an external control signal ESS of 1 is applied and in the high-resistance state when an external control signal ESS of 0 is applied.

### 2.) Simple Switching On/Off (Inverted)

Electronic switches are in the high-resistance state when an external control signal ESS of 1 is applied and in the low-resistance state when an external control signal ESS of 0 is applied.

[1 and 2—generally: when a first voltage level is applied, the high-resistance state is initiated, or when a second voltage level is applied, the low-resistance state is initiated]

### 3.) Current Impulse Switching

Electronic switches change state in the event of a rising (or falling) signal edge at the control input. In other words, a third voltage level that is applied for a first duration initiates the state change of the electronic switches.

4.) Current Impulse Switching with a Time Count/Timer

Electronic switches change to the on state in the event of a rising (or falling) signal edge at the control input. The electronic switches change automatically to the high-resistance state following a (settable) time. In other words, a third voltage level applied for a second duration causes the electronic switches to change to the low-resistance state, and following an in particular settable third duration, the electronic switches change to the high-resistance state.

### 5.) Delayed On

Electronic switches switch as in point 1 or 2, but with a settable switch-on delay.

### 6.) Delayed Off

Electronic switches switch as in point 1 or 2, but with a settable switch-off delay.

### Other Parameterization Options are:

7.) Only Opening of the Mechanical Contacts. The Isolating Contact is Opened for Example in the Event of an Edge Change in the Control Signal (or Signal Sequence).

This is indicated schematically in FIG. 7. FIG. 7 shows a parameterization configuration in which the external protective function is able to actuate 3 states.
A1=one or more mechanical contacts open, electronic switches in the high-resistance state (off state)
S1=one or more mechanical contacts closed, electronic switches in the high-resistance state (standby state)
E1=one or more mechanical contacts closed, electronic switches in the low-resistance state (on state)

The circuit breaker device is configured such that the contacts are opened by way of the control input CI. In other words, the external/internal control signal ESS/ESSI brings about the state A1.

FIG. 8 shows an illustration according to FIG. 7, with the difference that the external/internal control signal ESS/ESSI brings about simple on/off switching, is to say a low-resistance/high-resistance state of the electronic switches, by way of the switching logic function SF, wherein a high-resistance state occurs in the event of an applied “positive” logic one control signal ESS/ESSI, this being indicated by the state 1 in FIG. 8, and in the event of a lack of applied control signal ESS/ESSI, that is say logic zero, a low-resistance state should be initiated, this being indicated by the state 0 in FIG. 8.

FIG. 9 shows an illustration according to FIG. 8, with the difference that it is indicated that the circuit breaker device is designed or configured such that both the electronic switches are able to be changed over between the high-resistance/low-resistance state by the control signal ESS/ESSI, for example by a logic zero or one state, alternatively by the first sequence, that is to say series of zero/one states. On the other hand, however, the contacts are also able to be opened, for example by a second sequence SEQB. The switching of the mechanical contacts is detected in the example by the control signal configuration unit CSC. In other words, the electronic switches may be changed over between the high-resistance/low-resistance state via the control input CI. At the same time, the contacts (of the mechanical isolating contact unit) are able to be opened via a (switching) sequence stored in the circuit breaker device.

FIG. 10 shows an illustration according to FIGS. 7 to 9, with the difference that it is indicated that the circuit breaker device is designed such that a fault state is acknowledged by the control signal ESS/ESSI.

In other words, if the circuit breaker device is in state S1 due to the exceedance of current or/and current/time limit values, the control input CI may be used to acknowledge this state and reset it. The circuit breaker device may thus be switched from the state S1 to the state E1 following a fault (when the fault has gone away again). This may be carried out remotely; the device does not have to be switched to the state E1 in situ.

In other words, the circuit breaker device SG may be designed such that the control input CI is used to acknowledge a fault-induced high-resistance state of the electronic interruption unit, in particular that the fault-induced high-resistance state was initiated by the exceedance of current or/and current/time limit values in the low-voltage circuit,
such that the electronic switches are able to be switched to the low-resistance state or switch/change automatically to the low-resistance state when there are subsequently no more faults,
it in particular being able to be configured whether the control input is able to be used
a) to switch the electronic switches to a high-resistance or low-resistance state or
b) to acknowledge a fault-induced high-resistance state.

The circuit breaker device may furthermore be designed such that the control input CI:
a) in the event of an applied first voltage level, initiates the high-resistance state or, in the event of an applied second voltage level, initiates the low-resistance state or
b) changes the state through a briefly (for example shorter than 1 second) applied third voltage level, more specifically changes it to the low-resistance state through a briefly (for example shorter than 1 second) applied third voltage level, and changes it back to the high-resistance state through a subsequent third voltage level.

The display unit has for example display means, visible on the circuit breaker device, for displaying (showing) the high-resistance or low-resistance state of the electronic switches, for example by way of an LED display.

The contact position of the mechanical isolating contact unit is displayed by the handle, but this display provided by the handle does not show the switching state of the electronic interruption unit.

In particular, the switching state of the electronic switches may advantageously be displayed when the switching state has been changed/is switched on or off via the control input CI.

Although the invention has been described and illustrated in more detail by the exemplary embodiment, the invention is not restricted by the disclosed examples and other variations may be derived therefrom by a person skilled in the art without departing from the scope of the invention.

1-22. (canceled)

23. A circuit breaker device for protecting an electrical multiphase low-voltage AC circuit, the circuit breaker device comprising:
a housing having grid-side phase connections and load-side phase connections for phase conductors of the electrical multiphase low-voltage AC circuit;
series circuits each containing a mechanical phase contact and an electronic switch, wherein a respective series circuit of said series circuits electrically connects one of said grid-side phase connections to one of said load-side phase connections, wherein said mechanical phase contacts are switched together so as to open to avoid a current flow or to close so as to allow the current flow, wherein said electronic switches have semiconductor-based switching elements and are switched, by way of said semiconductor-based switching elements, to a high-resistance state of said semiconductor-based switching elements so as to avoid the current flow or a low-resistance state of said semiconductor-based switching elements so as to allow the current flow;
current sensors, wherein a respective one of said current sensors is provided for each of said series circuits to respectively ascertain a level of a current in a respective phase conductor of the phase conductors;
a controller being connected to said current sensors, said mechanical phase contacts and said electronic switches, wherein the circuit breaker device is configured such that, in an event of at least one first current threshold value and/or current/time limit value in a phase conductor being exceeded, avoidance of the current flow is initiated; and
a control input disposed on the circuit breaker device, wherein the circuit breaker device is configured such that said electronic switches are switched to the high-resistance state or the low-resistance state by way of said control input.

24. The circuit breaker device according to claim 23, wherein the circuit breaker device is configured such that said electronic switches are switched to the high-resistance state or the low-resistance state independently of one another by way of said control input.

25. The circuit breaker device according claim 23, wherein the circuit breaker device is configured such that, in an event of the at least one first current threshold value in the phase conductor being exceeded, avoidance of the current flow in the phase conductor is initiated by an associated said electronic switch.

26. The circuit breaker device according to claim 23, wherein said mechanical phase contacts are assigned to said load-side phase connections and said electronic switches are assigned to said grid-side phase connections.

27. The circuit breaker device according to claim 23, wherein said control input has safe galvanic isolation between said control input and the phase conductors.

28. The circuit breaker device according to claim 23, wherein:
said electronic switches are switched to the low-resistance state by way of said control input only when an enable condition is present; and
in an event of the high-resistance state, brought about by an external protective function of the circuit breaker device, of at least one of said electronic switches, one or more of said electronic switches are not able to be switched to the low-resistance state using said control input.

29. The circuit breaker device according to claim 23, wherein circuit breaker device-side checking functions that:
a) switch at least one of said electronic switches that is in the high-resistance state to the low-resistance state for a first time period; and/or
b) switch at least one of said electronic switches that is in the low-resistance state to the high-resistance state for a second time period;
are not able to be influenced by said control input.

30. The circuit breaker device according to claim 23, wherein said phase contacts are able to be opened by way of said control input, said control input being configured to be used to:
a) switch said electronic switches to the high-resistance state or the low-resistance state; or
b) open the phase contacts.

31. The circuit breaker device according to claim 23, wherein:
said control input is accessible on a side of said housing; and
said control input has at least one galvanic isolation element and a plurality of connection terminals, said connection terminals are connected, inside the circuit breaker device, to said at least one galvanic isolation element.

32. The circuit breaker device according to claim 23, further comprising a display connected to said controller and has a display means, visible on the circuit breaker device, for displaying the high-resistance state or the low-resistance state of said electronic switches.

33. The circuit breaker device according to claim 23, wherein the circuit breaker device is configured such that, in an event of a standby state, said control input initiates all of said electronic switches to be in the high-resistance state, the high-resistance state is established in a region of a current zero crossing of the current in a respective one of said electronic switches.

34. The circuit breaker device according to claim 23, further comprising a grid-side neutral conductor connection and a load-side neutral conductor connection each disposed on said housing for a neutral conductor of the electrical multiphase low-voltage AC circuit.

35. The circuit breaker device according to claim 34, further comprising a mechanical neutral conductor contact, said grid-side neutral conductor connection is connected to said load-side neutral conductor connection via said mechanical neutral conductor contact.

36. The circuit breaker device according to claim 35, wherein:
said mechanical neutral conductor contact is able to be opened or closed together with said mechanical phase contacts; or
said mechanical neutral conductor contact is closed before said mechanical phase contacts are closed or in that said mechanical neutral conductor contact is opened after said mechanical phase contacts have been opened.

37. The circuit breaker device according to claim 34,
further comprising voltage sensors, a respective one of said voltage sensors is connected to said controller and connected between each said phase conductor and the neutral conductor in order to ascertain a level of a voltage between the phase conductor and the neutral conductor; and
wherein in an event of a change to the low-resistance state, initiated by said controller or said control input coupled to said electronic switches, said change to the low-resistance state occurs in a region of a respective zero crossing of the voltage of the phase conductor.

38. The circuit breaker device according to claim 37, wherein in an event of a change to the high-resistance state, initiated by said controller or said control input, coupled to said electronic switches, the change to the high-resistance state, occurs in the region of the respective zero crossing of the voltage of the phase conductor.

39. The circuit breaker device according to claim 37, wherein:
said controller is connected to said current sensors, said voltage sensors, said mechanical phase contacts and said electronic switches; and
the circuit breaker device is configured such that, in an event of at least one current threshold value in a phase conductor being exceeded, avoidance of the current flow in the phase conductor in question is initiated by an associated said electronic switch, in that, at a next zero crossing of the voltage or the one after that, said associated electronic switch returns to the low-resistance state in order to enable the current flow.

40. The circuit breaker device according to claim 23, wherein the circuit breaker device is configured such that said control input:
a) in an event of an applied first voltage level, initiates the high-resistance state or, in an event of an applied second voltage level, initiates the low-resistance state; or
b) initiates a state change between the high-resistance state or the low-resistance state or the low-resistance state or the high-resistance state by way of a third voltage level that is applied for a first duration; or
c) initiates a change of said electronic switches to the low-resistance state by way of the third voltage level that is applied for a second duration and, following a settable third duration, said electronic switches change to the high-resistance state.

41. The circuit breaker device according to claim 23,
wherein the circuit breaker device is configured such that said control input is used to acknowledge a fault-induced high-resistance state of at least one said electronic switch, wherein the fault-induced high-resistance state has been initiated by an exceedance of a current and/or current/time limit values in the electrical multiphase low-voltage circuit, such that said electronic switches are switched to the low-resistance state or switch automatically to the low-resistance state when a fault is subsequently no longer present; and
said control input is configured to:
a) switch said electronic switches to the high-resistance state or the low-resistance state; or
b) to acknowledge the fault-induced high-resistance state.

42. A method for protecting an electrical multiphase low-voltage AC circuit, which comprises the steps of:
providing a circuit breaker device, containing:
a housing having grid-side phase connections and load-side phase connections for phase conductors of the electrical multiphase low-voltage AC circuit; and
series circuits each having a mechanical phase contact and an electronic switch, wherein a respective series circuit of the series circuits electrically connects one of the grid-side phase connections to one of the load-side phase connections, wherein the mechanical phase contacts are switched together so as to open in order to avoid a current flow or to close so as to allow the current flow, wherein the electronic switches are able to be switched, by way of semiconductor-based switching elements, to a high-resistance state of the switching elements so as to avoid the current flow or a low-resistance state of the switching elements so as to allow the current flow;
ascertaining a level of a current in the respective phase conductor in each of the series circuits;
initiating avoidance of the current flow in an event of at least one first current threshold value or current/time limit value in a phase conductor being exceeded; and
switching the electronic switches to the high-resistance state or the low-resistance state by way of a control input.

43. The method according to claim 42, wherein:
the electronic switches are switched to the low-resistance state by way of the control input only when an enable condition is present; and
in an event of the high-resistance state, brought about by a protective function of the circuit breaker device, of at least one said electronic switch, the electronic switches are not able to be switched to the low-resistance state using the control input.

44. The circuit breaker device according to claim 42, wherein circuit breaker device-side checking functions that:
a) switch the electronic switch that is in the high-resistance state to the low-resistance state for a first time period; or
b) switch the electronic switch that is in the low-resistance state to the high-resistance state for a second time period;
are not influenced by the control input.
